(19) United States
(12) Patent Application Publication
(10) Pub. No.: US 2010/0027559 A1
(43) Pub. Date: Feb. 4, 2010

(54) TRANSMISSION DEVICE AND DATA EXTENDED TRANSMISSION METHOD

(76) Inventors: Hung-Ming LIN, Hsin Chu City (TW); Hung-Ju Huang, Hsinchu City (TW); Jen-Min Yuan, Tai Chung City (TW); Ming-Chi Bai, Hsinchu City (TW)

Correspondence Address: Muncy, Geissler, Olds & Lowe, PLLC, P.O. BOX 1364, FAIRFAX, VA, 22038-1364, US

(21) Appl. No.: 12/203,007

(22) Filed: Sep. 2, 2008

(30) Foreign Application Priority Data
Jul. 31, 2008 (TW) 097129107

(51) Int. Cl. H04L 12/66

(52) U.S. Cl. 370/463

(57) ABSTRACT

The invention discloses a transmission device. The transmission device includes an interface circuit, a data converting circuit, at least a physical layer and a transmission medium. The interface circuit is used to receive a PCIe signal or a PCI signal. The data converting circuit is coupled to the interface circuit and used to convert the PCIe signal or the PCI signal into at least a data packet. The physical layer is coupled to the data converting circuit and used to process and transfer the data packet. The transmission medium receives and transfers the data packet.

### BACKGROUND OF THE INVENTION

(a) Field of the Invention

The present invention relates to a transmission device, and particularly to an extended data transmission device.

(b) Description of the Related Art

Currently, the distance for transmitting data of a general computer peripheral component interconnect express (PCIe) interface or computer peripheral component interconnect (PCI) interface is limited and, therefore, such data transmission can only be used for a short distance. To resolve the distance limitation problem of data transmission, a transmission line with the high definition multimedia interface (HDMI) specification has been proposed in other technical fields to increase the data transmission distance. However, using the transmission line consistent with the HDMI specification to transmit data causes the problem of increasing cost dramatically.

### BRIEF SUMMARY OF THE INVENTION

Therefore, in order to resolve the above mentioned problems, one object of the invention is to provide a transmission device that can transfer data through a general transmission line (such as: a network line or an optical fiber line).

One object of the invention is to provide a transmission device that can reduce the production cost.

One object of the invention is to provide a transmission device that can reduce the purchasing cost for consumers.

One object of the invention is to provide a transmission device that can increase the transmission distance dramatically.

According to one embodiment of the invention, a transmission device is provided. The transmission device includes an interface circuit, a data converting circuit, at least a physical layer circuit, and at least a transmission medium. The interface circuit receives at least a computer peripheral component interconnect express (PCIe) interface signal or at least a computer peripheral component interconnect (PCI) interface signal. The data converting circuit is coupled to the interface circuit for converting the interface signal into at least a data packet. The physical layer circuit is coupled to the data converting circuit for processing and transferring the data packet. The transmission medium receives and transmits the data packet.

According to another embodiment of the invention, a transmission device is provided. The transmission device includes a server terminal, at least a transmission medium, and at least a client terminal. The server terminal includes a first interface circuit, a first data converting circuit, and at least a first physical layer circuit. The first interface circuit receives at least a computer peripheral component interconnect express (PCIe) interface signal or at least a computer peripheral component interconnect (PCI) interface signal. The first data converting circuit is coupled to the first interface circuit for converting the interface signal into at least a data packet. The first physical layer circuit is coupled to the first data converting circuit for processing and transferring the at least one data packet. The transmission medium receives and transmits the at least one data packet. The client terminal includes at least a second physical layer circuit, a second data converting circuit, and a second interface circuit. The second physical layer circuit is coupled to the transmission medium for receiving the at least one data packet from the transmission medium. The second data converting circuit is coupled to the second physical layer circuit and receives the at least one data packet for converting the at least one data packet into the at least one computer peripheral component interconnect express (PCIe) interface signal or the at least one computer peripheral component interconnect (PCI) interface signal. The second interface circuit is coupled to the second data converting circuit for outputting the at least one computer peripheral component interconnect express (PCIe) interface signal or the at least one computer peripheral component interconnect (PCI) interface signal.

According to another embodiment of the invention, a data extended transmission method is provided. The method includes the following steps. At first, at least a computer peripheral component interconnect express (PCIe) interface signal or at least a computer peripheral component interconnect (PCI) interface signal is received. It is determined if the interface signal is consistent with the preset specification or size. The interface signal is converted into at least a data packet. The data packet is transmitted through the network line or the optical fiber line. Then, the data packet is received through the network line or the optical fiber. It is determined if the data of the data packet is correct according to the preset coding. Thereafter, the data packet is converted into the at least a computer peripheral component interconnect express (PCIe) interface signal or the at least a computer peripheral component interconnect (PCI) interface signal.

The transmission device and the data extended transmission method according to the embodiments of the invention utilize the data converting circuit to convert the computer peripheral component interconnect express (PCIe) interface signal or the computer peripheral component interconnect (PCI) interface signal into a data packet and then transfer the data packet through the transmission medium via the physical layer circuit. Therefore, the transmission device and the data extended transmission method according to the embodiments of the invention can accommodate long-distance data transmission through the network line or the optical fiber line. Besides, the physical layer circuit can be implemented by existing commonly available devices that are provided with the physical layer circuit. Thus, the existing commonly available network line or optical fiber line can be utilized as the transmission medium for such data transmission. In conclusion, by way of the above mentioned approaches, the transmission device and the method according to the embodiments of the invention can greatly reduce the design expense and the production cost while better transmission efficiency compared to the prior technique can be achieved.

### BRIEF DESCRIPTION OF THE DRAWINGS

FIG. 1A shows a schematic diagram illustrating the transmission device according to one embodiment of the invention;

FIG. 1B shows a schematic diagram illustrating the transmission device according to another embodiment of the invention;

FIG. 2 shows a schematic diagram illustrating the transmission device according to another embodiment of the invention;

FIG. 3 shows a schematic diagram illustrating the transmission device according to another embodiment of the invention; and

FIGS. 4A and 4B show flow charts illustrating the data extended transmission method according to one embodiment of the invention.

### DETAILED DESCRIPTION OF THE INVENTION

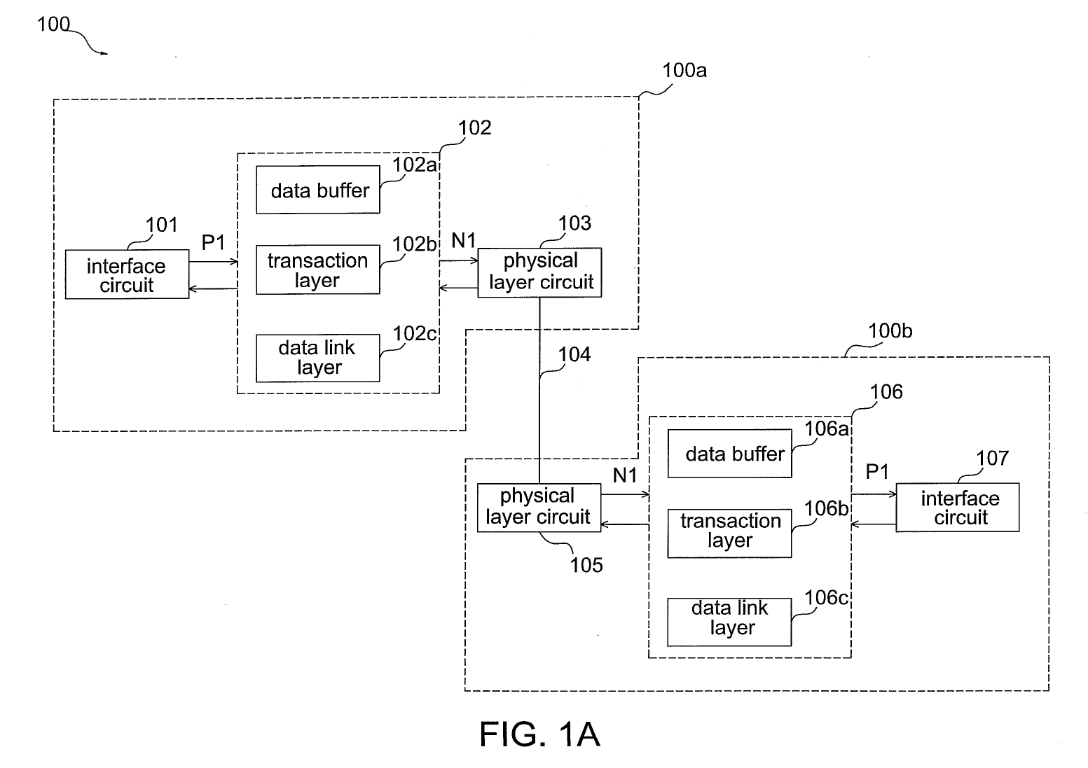

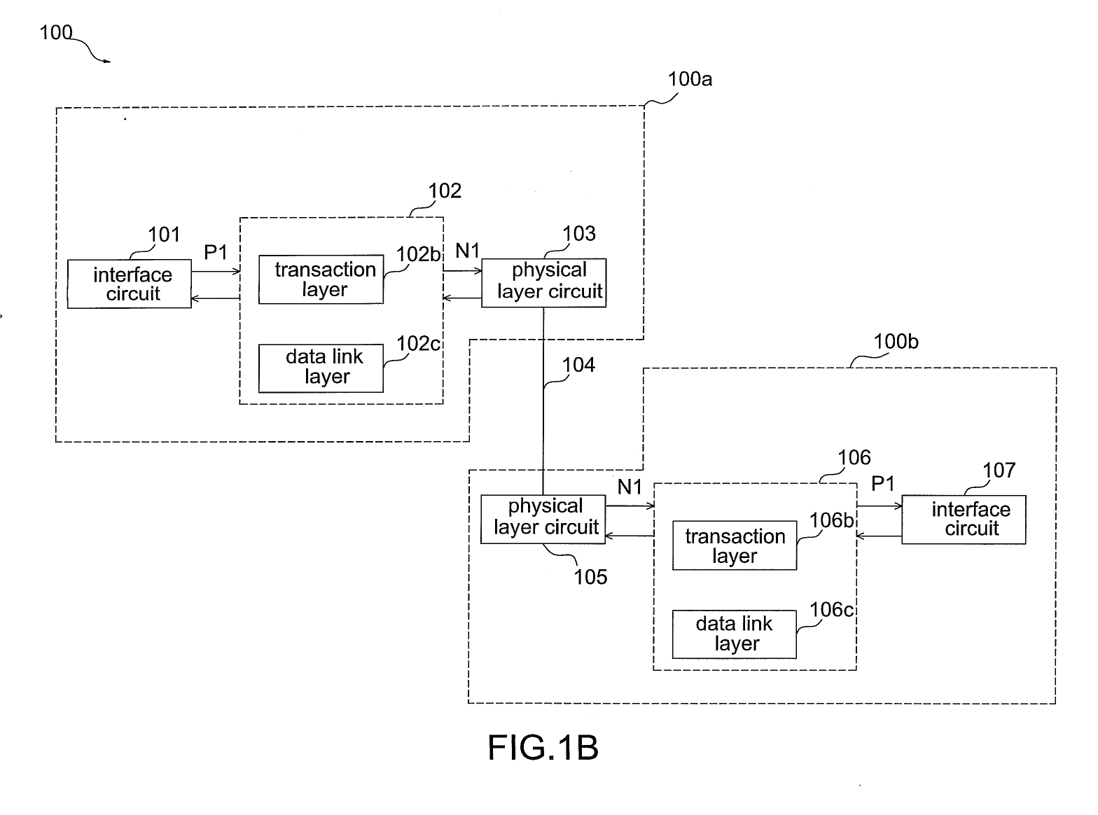

FIG. 1 shows schematic diagrams illustrating the transmission device according to one embodiment of the invention. A transmission device 100 includes a server terminal 100a and a client terminal 100b. The server terminal 100a includes an interface circuit 101, a data converting circuit 102, and a physical layer circuit 103. Correspondingly, the client terminal 100b also includes a physical layer circuit 105, a data converting circuit 106, and an interface circuit 107.

The interface circuit 101 according to one embodiment of the invention may be a computer peripheral component interconnect express (PCIe) interface circuit or the computer peripheral component interconnect (PCI) interface circuit for transferring at least a computer peripheral component interconnect express (PCI Express) interface signal (hereinafter abbreviated as: PCIe interface signal) or the computer peripheral component interconnect (PCI) interface signal (hereinafter abbreviated as: PCI interface signal) P1. Of course, in other embodiments, the interface circuit 101 may be any other existing interface circuits or interface circuits having specification to be developed in the future.

It should be noted that, in order to simplify the description to allow the content being expressed more clearly, only the PCIe interface signal P1 will be described hereinafter. Certainly, the PCI interface signal and other existing interface signals or various interface signals to be developed in the future can also be adopted according to the invention.

The data converting circuit 102 is coupled to the interface circuit 101 and used to convert the PCIe interface signal P1 into at least a data packet N1. The data packet N1 according to one embodiment of the invention may be a network packet or a packet that does not include the internet protocol (IP). The data packet N1 according to another embodiment of the invention can be a data packet having currently available specifications or various specifications to be developed in the future.

The data converting circuit 102 according to one embodiment of the invention includes a data buffer 102a, a transaction layer 102b, and a data link layer 102c. It should be noted that the data converting circuit 102 according to one embodiment of the invention may be a converting circuit for converting the computer peripheral component interconnect express (PCIe) interface or the computer peripheral component interconnect (PCI) interface into a media independent interface, a gigabit media independent interface, or various other kinds of physical layer interfaces (such as a kind of physical layer interface presets by a designer).

The data buffer 102a is used to perform data buffering process on the PCIe interface signal P1 to temporarily store the data of the PCIe interface signal P1 when the system intends to transfer the PCIe interface signal P1 to the client terminal 100b. At the same time, the transaction layer 102b determines if it is to receive the PCIe interface signal P1. Then, when the transaction layer 102b determines to receive the PCIe interface signal P1, the transaction layer 102b generates and supplies a request packet to the data link layer 102c according to the read/write request of the software layer (not shown in the figure). According to the request packet, the data link layer 102c processes the data temporarily stored in the data buffer 102a in order to output a process packet from the data buffer 102a to the data link layer 102c. It should be noted that, at the same time, the data buffer 102a will temporarily store a backup of the process packet to be used in re-transmission when an error occurs during the data transmission. Lastly, the data link layer 102c appends the header and the cyclic redundancy check (CRC) codes to the process packet and combines these data into a data packet N1 for transmitting to the physical layer circuit 103. The physical layer circuit 103 then transmits the data packet N1 through a transmission medium 104.

It should be noted that the physical layer circuits 103 and 105 according to the embodiments of the invention may be implemented by the existing devices having a physical layer circuit such as: modulator-demodulator (modem), IP sharing device, router, or the like with minor modifications or without modification. In conclusion, by way of the above mentioned approaches, the design expense and the production cost of the transmission device according to the embodiments of the invention can be greatly reduced. Of course, the physical layer circuits 103, 105 can also be implemented by circuits designed by the research and development personnel or circuits having the physical layer to be developed in the future. Besides, the physical layer circuits 103, 105 according to the embodiments of the invention may operate at various data transmission rates. For example, the physical layer circuit 103 may be operating at 10 Mbit, 100 Mbit, one giga-bit or other higher transmission rate (or a transmission rate presets by a designer). The transmission medium 104 according to the embodiments of the invention utilizes the network line or the optical fiber line, such as the existing commonly available: CAT-5, CAT-5e, CAT-6, or other transmission lines having higher transmission speed (speed presets by a designer), for transmission. As the cost of such transmission line is low, the embodiments of the invention can greatly reduce the production cost while achieving better transmission efficiency compared to the prior technique. Certainly, the embodiments according to the invention are not limited by these examples. Any existing commonly used transmission lines or other popular transmission lines to be developed in the future can also be used.

When the data packet N1 is transferred to the client terminal 100b, the physical layer circuit 105 transfers the data packet N1 to the data converting circuit 106. The data converting circuit 106 according to one embodiment of the invention may be a data converting circuit for converting the gigabit media independent (GMII) interface into computer peripheral component interconnect express (PCIe) interface. The data converting circuit 106 includes a data buffer 106a, a transaction layer 106b, and a data link layer 106c. The operating principle of the data converting circuit 106 is similar to the data converting circuit 102 of the server terminal 100a. It can be understood for those who are skilled in the art and will not be repeated hereinafter. Lastly, the data converting circuit 106 restores the data packet N1 into the PCIe interface signal P1 and transfers the PCIe interface signal P1 and the data contained in the signal P1 to the backend circuits (not shown in the figure) of the client terminal 100b through the interface circuit 107 for subsequent processing.

It should be noted that the server terminal 100a and the client terminal 100b according to the embodiment of the invention can provide bi-directional transmission. For example, the PCIe signal can also be received by the client terminal 100b and transmitted to the server terminal 100a through the transmission medium 104. Then, the PCIe signal is restored by the server terminal 100a. Therefore, the PCIe interface signal may be completely restored in the client terminal 100b or the server terminal 100a by the conversion of the data converting circuits 102, 106. Furthermore, the embodiments of the invention utilize the transmission medium 104 (such as: the network line or the optical fiber line) for data transmission to achieve the effect of long distance transmission between the server terminal 100a and the client terminal 100b and to resolve the data transmission distance limitation in the prior art.

Furthermore, the client terminal 100b may determine if the transmitted data is correct or not according to the cyclic redundancy check codes of the received data packet N1. When the data is incorrect, the client terminal 100b can transmit an error message to the server terminal 100a through the transmission medium 104. Then, the server terminal 100a re-processes the data that is temporarily stored in the data buffer 102a and transmits the data to the client terminal 100b through the transmission medium 104 for another check. This process repeats itself until the data is correctly received.

According to another embodiment of the invention, the above mentioned cyclic redundancy check codes may be replaced by an error correction code (ECC). When using the error correction code, both of the server terminal 100a and the client terminal 100b can omit the data buffers 102a, 106a as shown in FIG. 1B. The server terminal 100a and the client terminal 100b may perform data correction based on the error correction code without using the data buffers 102a, 106a. Therefore, the area of the circuits to implement the embodiments of the invention can be reduced and the production cost can be reduced.

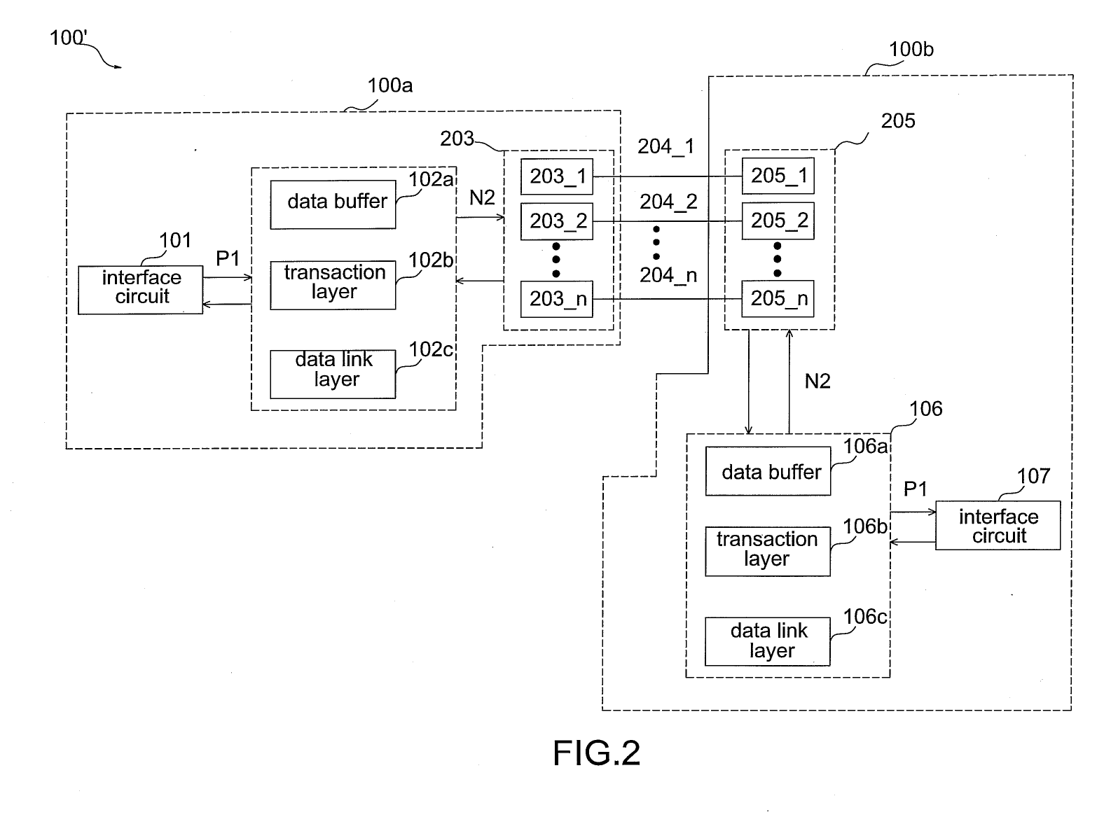

FIG. 2 shows a schematic diagram illustrating the transmission device 100′ according to another embodiment of the invention. The operating principle of the transmission device 100′ is similar to the above mentioned embodiments of the invention. The difference lies in the physical layer circuit 203 of the transmission device 100′ that can include n number of (where n is a positive integer and n is less than infinity) sub-physical layer circuits 203_1˜203_{—}n. According to the architecture of the embodiment, the transmission device 100′ can divide a relatively large data packet N2 into n number of relatively small data packets and perform data transmission through n number of transmission media 204_1˜204_{—}n, respectively. Similarly, the n number of sub-physical layer circuits 205_1˜205_{—}n of the physical layer circuit 205 of the client terminal 100b receive the n number of relatively small data packets and combine these received data packets, and then provide the combined data packet(s) to the data converting circuit 106 for data conversion. Hence, the transmission device 100′ according to the embodiment of the invention can increase the data transmission speed and the transmission efficiency. Transmitting a packet between the server terminal 100a and the client terminal 100b through the approach of dividing the packet can resolve the network congestion problem especially when transmitting a large quantity of packets.

It should be noted that, through the description of the above mentioned examples, those who are skilled in the art should be able to understand that the client terminal 100b of the above embodiments of the invention may also transmit data to the server terminal 100a for bi-directional data transmission and thus detail descriptions will not be repeated hereinafter. Besides, the information transmitted by the transmission device of the above embodiments of the invention is processed via the signal complying with the PCIe specification. Of course, the information transferred and processed by the transmission device according to the embodiments of the invention may include information according to various different specifications or formats, such as: instruction, data, image, audio, program code, control code, or any combination of the above, information according to various currently existing specifications, or information according to various specifications to be developed in the future.

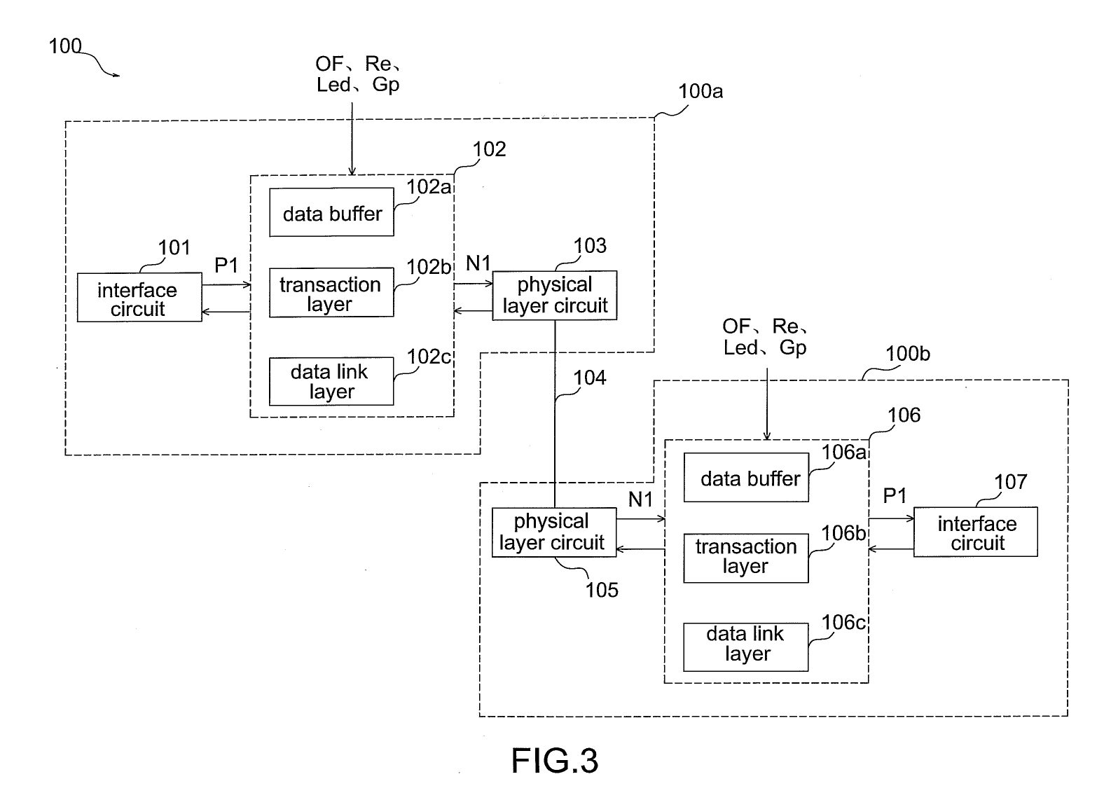

Furthermore, the transmission device according to the embodiments of the invention may process other signals and be provided with the functionality of remote control and remote management. The data converting circuit 102 of the server terminal 100a shown in FIG. 3 may process other signals such as: On/Off (OF), reset signal (Re), light emitting diode indicating signal (Led), general purpose I/O (GPIO), or any combination of the above. It should be noted that the data converting circuit 106 of the client terminal 100b may also be provided with the same functionality. Those who are skilled in the art should be able to understand how to utilize these signals to perform remote control and remote management and thus detail descriptions will not be repeated hereinafter.

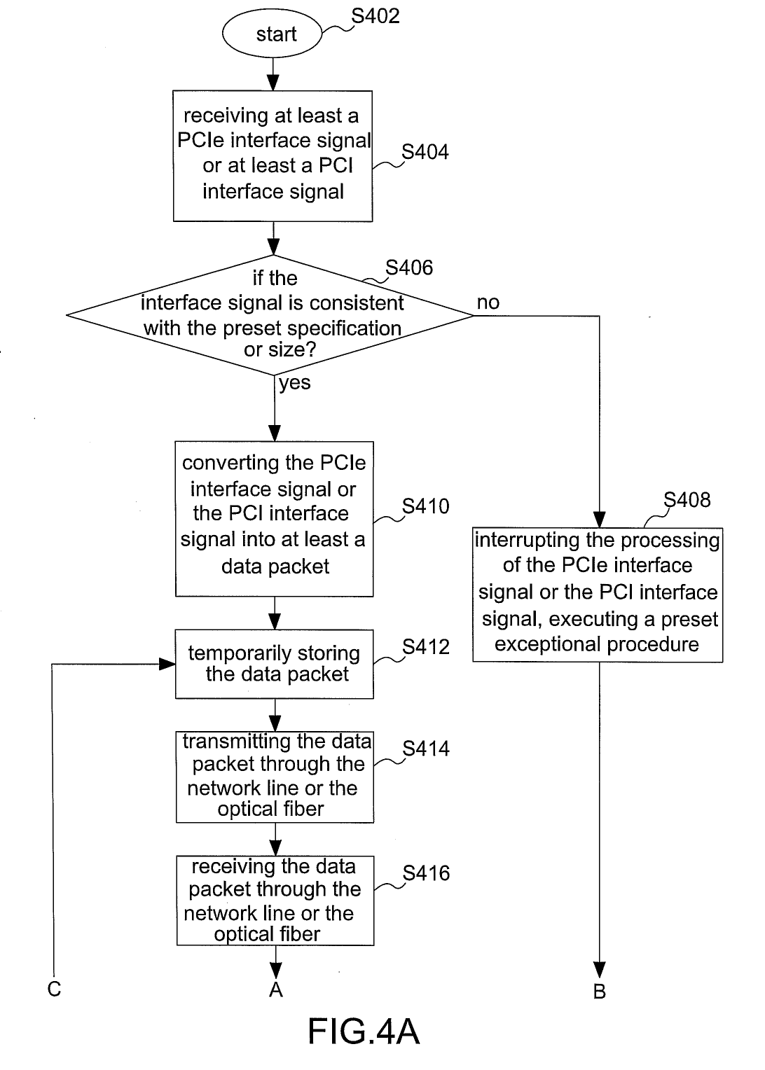

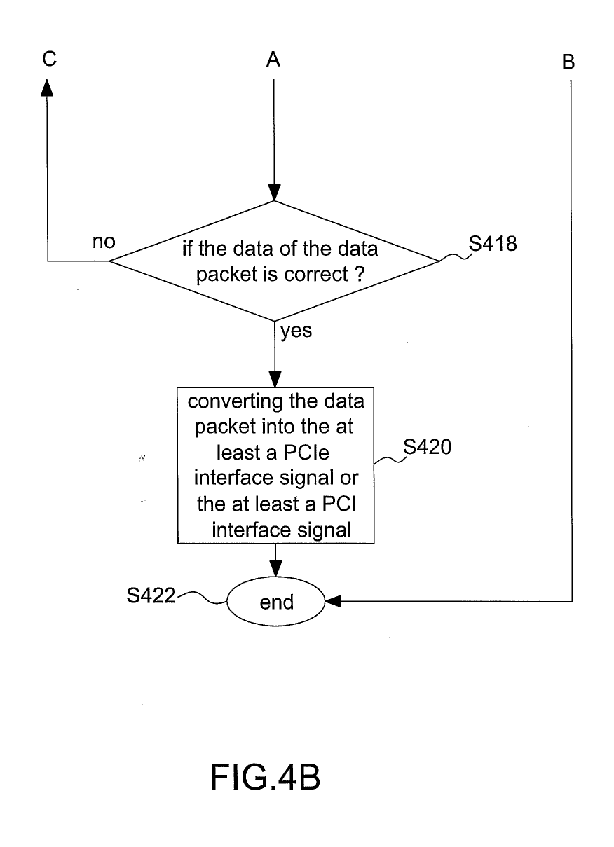

FIGS. 4A and 4B show flow charts illustrating the data extended transmission method according to one embodiment of the invention. It comprises the following steps:

Step S402: start;

Step S404: receiving at least a computer peripheral component interconnect express (PCIe) interface signal or at least a computer peripheral component interconnect (PCI) interface signal;

Step S406: determining if the computer peripheral component interconnect express (PCIe) interface signal or the computer peripheral component interconnect (PCI) interface signal is consistent with the preset specification or size, and jumping to Step S410 if yes, or jumping to Step 408 if not;

Step S408: interrupting the processing of the computer peripheral component interconnect express (PCIe) interface signal or the computer peripheral component interconnect (PCI) interface signal, executing a preset exceptional procedure, such as: executing the target-abort procedure preset in the PCIe interface signal according to one embodiment, and then jumping to Step S422;

Step 410: converting the computer peripheral component interconnect express (PCIe) interface signal or the computer peripheral component interconnect (PCI) interface signal into at least a data packet;

Step 412: temporarily storing the data packet;

Step 414: transmitting the data packet through the network line or the optical fiber;

Step 416: receiving the data packet through the network line or the optical fiber;

Step 418: determining if the data of the data packet is correct or not according to the preset coding, and jumping to Step S420 if yes, or jumping to Step 412 if not;

Step 420: converting the data packet into the at least a computer peripheral component interconnect express (PCIe) interface signal or the at least a computer peripheral component interconnect (PCI) interface signal;

Step S422: end.

The transmission device and the data extended transmission method according to the embodiments of the invention utilize the data converting circuit to convert the computer peripheral component interconnect express (PCIe) interface signal or the computer peripheral component interconnect (PCI) interface signal into a data packet and then transmit the data packet through the transmission medium via the physical layer circuit. By way of such approach, the transmission device and the data extended transmission method according to the embodiments of the invention can perform long distance data transmission through the network line or the optical fiber line under the prerequisite of lower cost.

Furthermore, the physical layer circuit of the transmission device according to the embodiments of the invention can be implemented by the existing devices provided with physical layer circuit while the transmission medium of the transmission device according to the embodiments of the invention can also utilize the existing network line or optical fiber line for data transmission. In conclusion, by way of the above mentioned approaches, the transmission device according to the embodiments of the invention can greatly reduce the design expense and the production cost while achieving the same or better transmission efficiency compared to the prior technique.

What is claimed is:

1. A transmission device, comprising:
an interface circuit for receiving at least a computer peripheral component interconnect express (PCIe) interface signal or at least a computer peripheral component interconnect (PCI) interface signal;
a data converting circuit, coupled to the interface circuit, for converting the computer peripheral component interconnect express interface signal or the computer peripheral component interconnect interface signal into at least a data packet;
at least a physical layer circuit, coupled to the data converting circuit, for processing and transferring the data packet; and
at least a transmission medium for receiving and transferring the data packet.

2. The transmission device according to claim 1, wherein the computer peripheral component interconnect express interface signal or the computer peripheral component interconnect interface signal comprises one selected from the group consisting of the following: instruction, data, image, audio, program code, control code, or any combination of the above.

3. The transmission device according to claim 1, wherein the data converting circuit comprises:
a transaction layer for determining if the computer peripheral component interconnect express interface signal or the computer peripheral component interconnect interface signal is to be received and for determining if a request packet is to be generated; and
a data link layer for processing the data of the computer peripheral component interconnect express interface signal or the computer peripheral component interconnect interface signal according to the request packet to generate the data packet.

4. The transmission device according to claim 3, wherein the data converting circuit further comprises:
a data buffer for temporarily storing the computer peripheral component interconnect express interface signal or the computer peripheral component interconnect interface signal.

5. The transmission device according to claim 4, wherein the data packet comprises a header, the data of the computer peripheral component interconnect express interface signal or the computer peripheral component interconnect interface signal, and a cyclic redundancy check (CRC) code.

6. The transmission device according to claim 3, wherein the data packet comprises a header, the data of the computer peripheral component interconnect express interface signal or the computer peripheral component interconnect interface signal, and an error correction code (ECC).

7. The transmission device according to claim 1, wherein the data converting circuit comprises a converting circuit for converting the computer peripheral component interconnect express interface or the computer peripheral component interconnect interface into a media independent interface, a giga media independent interface, or a kind of physical layer interface preset by a designer.

8. The transmission device according to claim 1, wherein the physical layer circuit is selected from the group consisting of the following: a gigabit physical layer circuit, a 10/100 Mbit physical layer circuit, a 10 Giga bit physical layer circuit, or a physical layer circuit having transmission speed preset by a designer.

9. The transmission device according to claim 1, wherein the transmission medium comprises a network line or an optical fiber line.

10. A transmission device, comprising: a server terminal and at least a client terminal;
wherein the server terminal comprises:
a first interface circuit for receiving at least a computer peripheral component interconnect express interface signal or at least a computer peripheral component interconnect interface signal;
a first data converting circuit, coupled to the first interface circuit, for converting the computer peripheral component interconnect express interface signal or the computer peripheral component interconnect interface signal into at least a data packet;
at least a first physical layer circuit, coupled to the first data converting circuit, for processing and transferring the at least one data packet; and
at least a transmission medium for receiving and transferring the data packet; and
the at least a client terminal, comprises:
at least a second physical layer circuit, coupled to the transmission medium, for receiving the at least one data packet from the transmission medium;
a second data converting circuit, coupled to the second physical layer circuit and receiving the at least one data packet, for converting the at least one data packet into the at least one computer peripheral component interconnect express interface signal or the at least one computer peripheral component interconnect interface signal; and
a second interface circuit, coupled to the second data converting circuit, for outputting the at least one computer peripheral component interconnect express interface signal or the at least one computer peripheral component interconnect interface signal.

11. The transmission device according to claim 10, wherein the computer peripheral component interconnect express interface signal or the computer peripheral component interconnect interface signal comprises one selected from the group consisting of the following: instruction, data, image, audio, program code, control code, or any combination of the above.

12. The transmission device according to claim 10, wherein the data converting circuit comprises: a data buffer for temporarily storing the computer peripheral component interconnect express interface signal or the computer peripheral component interconnect interface signal.

13. The transmission device according to claim 10, wherein the data packet comprises a header, the data of the computer peripheral component interconnect express interface signal or the computer peripheral component interconnect interface signal, and a cyclic redundancy check (CRC) code.

14. The transmission device according to claim 10, wherein the data packet comprises a header, the data of the computer peripheral component interconnect express interface signal or the computer peripheral component interconnect interface signal, and an error correction code (ECC).

15. The transmission device according to claim 10, wherein the transmission medium comprises a network line or an optical fiber line.

16. A data extended transmission method, comprising:
receiving at least a computer peripheral component interconnect express interface signal or at least a computer peripheral component interconnect interface signal;
determining if the computer peripheral component interconnect express interface signal or the computer peripheral component interconnect interface signal is consistent with the preset specification or size;
converting the computer peripheral component interconnect express interface signal or the computer peripheral component interconnect interface signal into at least a data packet when the computer peripheral component interconnect express interface signal or the computer peripheral component interconnect interface signal is consistent with the preset specification or size;
transmitting the data packet through the network line or the optical fiber;
receiving the data packet through the network line or the optical fiber;
determining if the data of the data packet is correct according to the preset coding; and
converting the data packet into the at least a computer peripheral component interconnect express interface signal or the at least a computer peripheral component interconnect interface signal.

17. The data extended transmission method according to claim 16, wherein a preset conditional procedure is executed to interrupt the processing of the computer peripheral component interconnect express interface signal or the computer peripheral component interconnect interface signal when the computer peripheral component interconnect express interface signal or the computer peripheral component interconnect interface signal is not consistent with the preset specification or size.

18. The data extended transmission method according to claim 16, wherein the computer peripheral component interconnect express interface signal or the computer peripheral component interconnect interface signal comprises one selected from the group consisting of the following: instruction, data, image, audio, program code, control code, or any combination of the above.

19. The data extended transmission method according to claim 16, wherein the data packet comprises a header, the data of the computer peripheral component interconnect express interface signal or the computer peripheral component interconnect interface signal, and a cyclic redundancy check (CRC).

20. The data extended transmission method according to claim 16, wherein the data packet comprises a header, the data of the computer peripheral component interconnect express interface signal or the computer peripheral component interconnect interface signal, and an error correction code (ECC).

21. The data extended transmission method according to claim 16, wherein the network line comprises one selected from the group consisting of the following: CAT-5, CAT-5e, CAT-6, or the specification having speed preset by a designer.
